(19) United States
(12) Patent Application Publication
(10) Pub. No.: US 2013/0068756 A1
(43) Pub. Date: Mar. 21, 2013

(54) METHOD AND APPARATUS FOR HEATING A METAL PLATE

(71) Applicant: Benteler Automobiltechnik GmbH, Paderborn (DE)

(72) Inventors: Jochen Doerr, Bad-Driburg (DE); Jochen Grewe, Salzkotten (DE); Borek Dvorak, Jablonec nad Nisou (CZ); Radovan Kout, Liberec (CZ)

(73) Assignee: Benteler Automobiltechnik GmbH, Paderborn (DE)

(21) Appl. No.: 13/621,638

(22) Filed: Sep. 17, 2012

(30) Foreign Application Priority Data
Sep. 16, 2011 (DE) 10 2011 053 672.8

(51) Int. Cl. F27D 1/00; H05B 6/02; H05B 1/00

(52) U.S. Cl. 219/600; 432/1; 219/162; 432/247

(57) ABSTRACT

In a method for heating a metal plate, the metal plate is placed between an lower contact element and an upper contact element. The contact elements are provided with heating units and integrated in mounts. At least one of the contact elements is shaped to suit a contour of the metal plate and made of a heat conducting material with a conductivity of at least 150 W/mK. The metal plate is heated between the contact elements to a temperature of 200° C. to 450° C. for a time period of less than 120 s in the presence of a contact pressure.

### CROSS-REFERENCES TO RELATED APPLICATIONS

This application claims the priority of German Patent Application, Serial No. 10 2011 053 672.8, filed Sep. 16, 2011, pursuant to 35 U.S.C. 119(a)-(d), the content of which is incorporated herein by reference in its entirety as if fully set forth herein.

### BACKGROUND OF THE INVENTION

The present invention relates to a method and apparatus for heating a metal plate.

The following discussion of related art is provided to assist the reader in understanding the advantages of the invention, and is not to be construed as an admission that this related art is prior art to this invention.

It is generally known to heat a metal plate for a short time to a temperature between 300° C. and 380° C. to make it more malleable.

It would be desirable and advantageous to provide an improved method and apparatus for heating a metal plate to obviate prior art shortcomings.

### SUMMARY OF THE INVENTION

According to one aspect of the present invention, a method includes placing a metal plate in a heating device between lower and upper contact elements of a contour matching a contour of the metal plate, supplying heating energy to at least one of the lower and upper contact elements which is made of a heat conducting material defined by a conductivity of at least 150 W/mK, and heating the metal plate in at least one heating phase to a temperature of 200° C. to 450° C. for a time period of less than 120 s in the presence of a contact pressure.

In accordance with the present invention, a metal plate which may be made of steel or light metal or also wrought aluminum alloy is placed between lower and upper contact elements which have confronting sides that are shaped to conform to the contour of the metal plate. Thus, the metal plate may have a planar configuration or also be preformed. The at least one contact element that is made of heat conducting material with a conductivity of at least 150 W/mK may also be heated. After positioning the metal plate between the contact elements, the contact elements are moved towards one another and are pressed against the metal plate to exactly follow its contours. The presence of the contact pressure is instrumental in completing the heating process of the metal plate. During the heating phase, the metal plate is heated to a temperature of 200° C. to 450° C. for a time period of less than 120 s.

In the event, the metal plate is made of steel, the heating phase is less than 120 s depending on the plate thickness, e.g. less than 60 s. Currently preferred is a heating phase of less than 20 s. Is the metal plate made of light metal, the time period of the heating phase is less than 60 s, e.g. 20 s. Currently preferred is a heating phase of less than 8 s.

According to another advantageous feature of the present invention, the lower contact element can be integrated in a lower mount and the upper contact element can be integrated in an upper mount.

Of course, both the lower and upper contact elements may be heated. In this case, both contact elements are made of heat conducting material with a conductivity of at least 150 W/mK. The heating phase of the at least one contact element may be executed electrically. It may also be conceivable to provide hydraulic heating of the at least one contact element. Regardless, whether the at least one contact element is heated electrically or hydraulically, the heating temperature may lie significantly above the targeted heating temperature for the metal plate. The heating temperature may be ascertained for example by sensors bearing upon the metal plate and can be used for realizing a precise control of the heating time.

According to another advantageous feature of the present invention, the at least one heatable contact element is thermally insulated against the environment. In this way, heat energy is used more efficiently.

According to another advantageous feature of the present invention, lubricant may be applied onto the metal plate before or after heating the metal plate. The lubricant may, for example, be applied by spraying, advantageously across the entire surface area to ensure even heat transfer from the at least one contact element into the metal plate.

According to another aspect of the present invention, an apparatus for heating a metal plate includes a heating device having a lower contact element integrated in a lower mount and an upper contact element integrated in an upper mount, with the lower and upper contact elements being movable vertically in relation to one another so as to be pressable against the metal plate and having confronting sides of a contour matching a contour of the metal plate, wherein the heating device further includes a heating unit provided in at least one of the contact elements which is made of a heat conducting material defined by a conductivity of at least 150 W/mK.

As described above, the metal plate may be planar or already preformed.

After positioning the metal plate between the spaced-apart contact elements, the contact elements are moved by the mounts towards one another and are pressed against the metal plate to exactly follow its contours. The metal plate is heated as a result of heating at least one of the contact elements to the desired temperature range of 200° C. to 450° C. Heating may be executed in dependence on the respective thickness of the metal plate and the material (steel, light metal, such as aluminum) in a shortest possible time, advantageously at a time of less than 20 s, when a steel plate is involved, or less than 8 s, when a light metal plate is involved. After the metal plate undergoes heating, the contact elements are moved apart by the mounts and the heated metal plate can be transferred for further processing, e.g. to undergo a forming process.

In the event both contact elements are made of heat conducting material with a conductivity of at least 150 W/mK, each contact element is provided with a heating unit. When only one contact element is made of heat conducting material with a conductivity of at least 150 W/mK, it is advantageous to make the other one of the contact elements of a material with a conductivity which is less than the conductivity of the material of the one contact element. Advantageously, the other one of the contact elements may be made of insulating material. As a result, heat is prevented to dissipate from the metal plate into neighboring components via the unheated contact element.

According to yet another aspect of the present invention, an apparatus for heating a metal plate includes a heating device having a base frame, two lower mounts which are supported side-by-side on the base frame and guided by the base frame for movement in a vertical direction, with each lower mount having integrated therein a lower contact element, and an upper mount having integrated therein an upper contact element and movable above the lower mounts and lockable with the lower mounts in the presence of a contact pressure, wherein at least one of the lower and upper mounts is provided with a heating unit, and a pressing mechanism integrated in the lower mounts.

In this embodiment, one of the lower contact elements can thus be open-ended and freed from the heated metal plate and can thus receive a cold metal plate while heating of a metal plate takes place between the other one of the lower contact elements and the upper contact element which has been moved to a position above this lower contact element. Displacement of the upper mount with the upper contact element from one lower mount with contact element to the other mount with contact element may be translatorily or rotationally. Suitably configured transfer robots may hereby be used. The transfer of a cold metal plate to the heating device thus occurs alternatingly from one end face of the heating device and the discharge of a heated metal plate occurs towards the other end face thereof.

According to another advantageous feature of the present invention, the pressing mechanism may be realized in the form of a pneumatically-operated padding which, after both contact elements have moved towards one another, acts from below in opposition to the pressing force from above. The provision of such a padding allows a targeted uniformity of the contact pressure upon the metal plate placed between the contact elements.

According to still another aspect of the present invention, an apparatus for heating a metal plate includes a heating device having a base frame, two lower mounts supported in spaced-apart relationship on the base frame and having each integrated therein a lower contact element, and two upper mounts which have each integrated therein an upper contact element and are arranged above the lower mounts and which are lockable with the lower mounts in the presence of a contact pressure, wherein at least one of the lower and upper contact elements placed above each other is provided with a heating unit, and a pressing mechanism integrated between the base frame and the lower mounts.

This type of heating device permits a pre-heating of one metal plate between two contact elements lying above one another, whereas another metal plate undergoes heating to the desired end temperature between the other pair of upper and lower contact elements. Thus, a metal plate can be transferred from a transfer station to a pre-heat station, then transferred to a final heating station, and ultimately removed from the heating device for further processing. The metal plate advances translatorily through the heating device from one end face to the other end face. Transfer robots may also be used in this embodiment to implement the displacement of the metal plate.

It is, however, also conceivable to place a metal plate from one end face of the heating device between two contact elements, to heat it there, and then to remove it from the same side of the heating device. The upper mounts are connected to one another by a rigid support arm and jointly movable vertically. Supply and removal of metal plates may also be implemented using transfer robots.

According to still another aspect of the present invention, an apparatus for heating a metal plate includes a heating device having four rotatably supported lower mounts which are arranged at 90° offset relation and have integrated therein lower contact elements, two upper mounts which are arranged at 180° offset relation and have integrated therein upper contact elements and which are coupleable and lockable with the lower mounts in the presence of a contact pressure, wherein at least one of the lower and upper contact elements placed above each other is provided with a heating unit, and a pressing mechanism integrated between the base frame and the lower mounts.

According to another advantageous feature of the present invention, the upper mounts can be coupled to one another by a rigid support arm and provided with the heating units. Suitably, the upper mounts are immobile and the lower contact elements are not heatable. This embodiment is simple to realize in practice.

In this embodiment of a heating device, two cold metal plates are transferred at any time from two separate opposite sides (logistics zones) to two free lower contact elements, whereas metal plates are heated between the 90° rotated lower contact elements and the upper contact elements lying above.

After complete heating, the lower and upper mounts with the integrated contact elements are separated from one another in the heating stations, the heated metal plates are expelled from opposite sides, the four lower mounts are moved about 90° in circumferential direction, cold metal plates are placed into the now empty lower contact elements, and heating of the metal plates placed onto the previously empty contact element is carried out between the lower and upper contact elements.

Thus, the heated metal plates can be transferred, for example, to two different, in particular opposite forming stations (presses) which operate in a same cycle.

Instead of the four lower mounts that are shiftable by 90° respectively, it is also conceivable to provide two mounts that are arranged in 180° offset relationship underneath the two upper mounts and are offset by 90° with respect to the two ready stations (logistics stations). Using grippers (transfer robots), cold metal plates can be moved from the logistics zones between the lower and upper mounts and subsequently heated.

An advantageous feature of the present invention is the presence of pressing and/or locking mechanisms to impact the stacked lower and upper mounts and thus indirectly also the integrated lower and upper contact elements, respectively. The pressing and/or locking mechanisms may act on both sides or only on one side upon the mounts and may be of electric, mechanic, hydraulic, or pneumatic nature. The contact pressure of the mounts and thus of the contact elements upon the metal plate to be heated should ensure a complete formfit/surface contact which is maintained over the entire heating phase of the metal plate. Advantageously, the respective locking mechanism should be configured with short locking and opening times. This can be realized by short closing distances and rapid drives which may operate pneumatically, mechanically and may optionally also be preloaded.

The heating period of a metal plate can be controlled mainly through control of the closing duration. Additional lifting/lowering bolts (lifting elements) for the metal plate may be provided in the lower contact elements to effect a precise control. The pins or bolts lift a heated metal plate after removal of the upper contact element or mount from the lower contact element so that the metal plate is isolated from the heat energy source. This may take place simultaneously or time-staggered so that a certain fine-tuning of the heating process becomes possible. In the event, the heating time represents a bottleneck with respect to time in the manufacturing line, it may be conceivable to measure—just in time (JIT)—the heat distribution by using a thermo camera during transfer to a forming press and to accordingly correct the heating time of the next following metal plate or the lifting delay via the pins or bolts.

The contact elements may be made of aluminum alloy. It is, of course, also conceivable to make the contact elements of a material having a thermal conductivity comparable to a thermal conductivity of an aluminum alloy.

It is not desired to heat the environment of the contact elements, in particular the devices that are used to apply the pressure forces. For that reason, it is advantageous to thermally insulate the heating contact element from the environment.

According to another advantageous feature of the present invention, the upper and lower contact elements have metal-plate-confronting sides which can be coated. In this way, the service life of the heating device can be increased.

According to another advantageous feature of the present invention, the heating device may include a thermal insulation between a heatable contact element and the associated mount. The thermal insulation may, e.g., be configured as an insulation board.

According to another advantageous feature of the present invention, the mount for a heatable contact element can be cooled.

The contact element can be heated by an inductor, e.g. in the form of an encapsulated induction coil. It is, of course, also conceivable to configure in a heatable contact element at least one passageway in which a heating fluid is guided.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 is a schematic, partly sectional view of a first embodiment of a heating device according to the present invention for heating a metal plate;

FIG. 2 is a schematic, partly sectional view of a second embodiment of a heating device according to the present invention for heating a metal plate;

FIG. 3 is a side view of the heating device of FIG. 2, depicting a further operating position;

FIG. 4 is a schematic, partly sectional view of a third embodiment of a heating device according to the present invention for heating a metal plate;

FIG. 5 is a schematic, partly sectional view of a fourth embodiment of a heating device according to the present invention for heating a metal plate;

FIG. 6 is a schematic, partly sectional view of a fifth embodiment of a heating device according to the present invention for heating a metal plate;

FIG. 7 is a schematic, partly sectional view of the heating device of FIG. 1, depicting a heating unit in the form of an inductor;

FIG. 8 is a schematic, partly sectional view of the heating device of FIG. 1, depicting a heating unit in the form of a passageway for heating fluid;

FIG. 9 is a schematic, partly sectional view of the heating device of FIG. 1, depicting coated confronting sides of contact elements; and

FIG. 10 is a schematic, partly sectional view of the heating device of FIG. 1, depicting a cooling system integrated in a mount for a contact element.

### DETAILED DESCRIPTION OF PREFERRED EMBODIMENTS

Throughout all the figures, same or corresponding elements may generally be indicated by same reference numerals. These depicted embodiments are to be understood as illustrative of the invention and not as limiting in any way. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

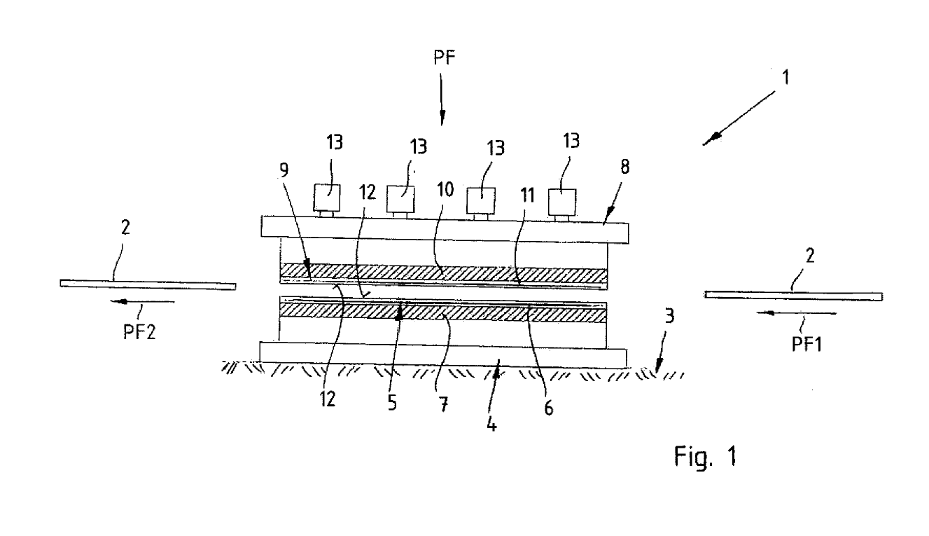

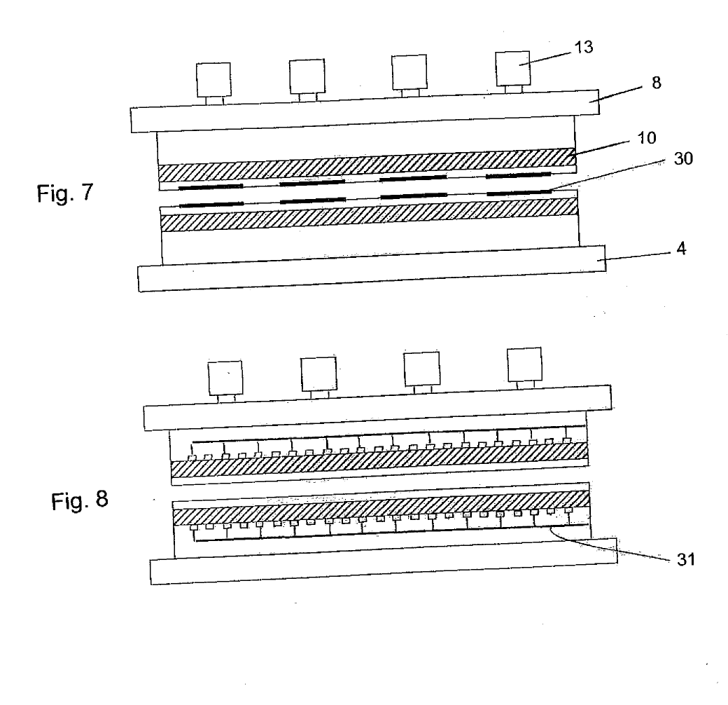

Turning now to the drawing, and in particular to FIG. 1, there is shown a schematic, partly sectional view of a first embodiment of a heating device according to the present invention, generally designated by reference numeral 1 for heating a metal plate 2 which can be made of light metal for example. The heating device 1 includes a lower mount 4 which is arranged on a base 3, not described in greater detail, and made of steel or aluminum sections. The lower mount 4 carries a heatable lower contact element 5 which is made of heat-conducting material with a heat conductivity of at least 150 W/mK. An example of such a material includes aluminum alloy. A heating unit 6 disposed in the lower contact element 5 may be configured as inductor 30, as shown in FIG. 7, configured e.g. as an encapsulated inductor coil which may be cast for example in an enclosure for insulation and protection against aggressive fluids, or in the form of a passageway 31 for guiding a heating fluid, e.g. thermal oil which is cracking proof up to a temperature of 350° C., as shown in FIG. 8. The inductor 30 may involve a high-frequency inductor as area indictor having meandering windings. A thermal insulation 7 is placed between the lower contact element 5 and the lower mount 4.

Arranged above the lower mount 4 is an upper mount 8 which is also made of steel or aluminum sections. The slight inert mass of aluminum sections renders them beneficial for lightweight construction, in particular for small-scale production.

In the non-limiting example of FIG. 1, a heatable upper contact element 9 is integrated in the upper mount 8 and is heat-insulated from the upper mount 8 by a thermal insulation 10. A heating unit 11 provided in the upper contact element 9 can be configured as inductor, e.g. an encapsulated inductor coil, or in the form of a passageway for guiding a heating fluid.

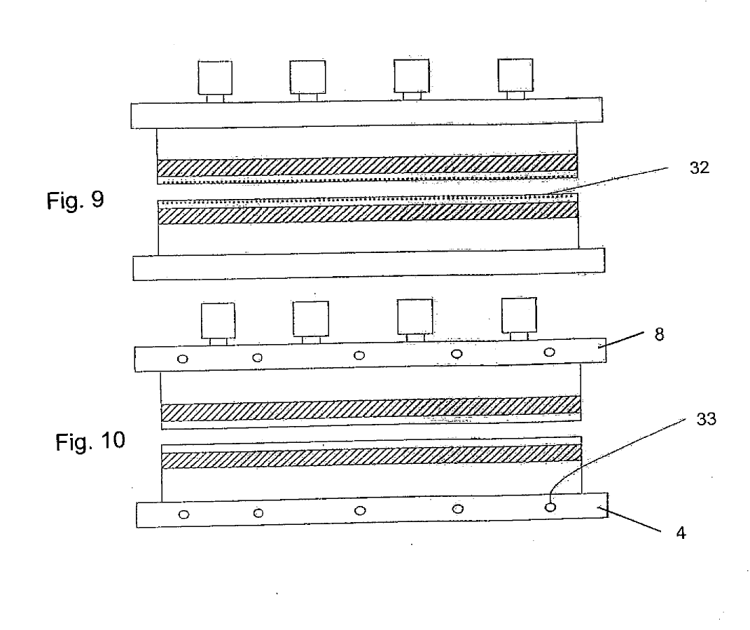

The contact elements 5, 9 have confronting sides 12 which are coated, as shown in FIG. 9 and indicated by reference numeral 32. The coating 32 may be a PVD (Physical Vapor Deposition) coating, e.g. DLC (Diamond-Like Carbon) coating or hard chrome coating, applied in an immersion bath and having non-stick property. The sides 12 are shaped to conform to the contour of the metal plate 2 which is placed between the two contact elements 5, 9 and heated between the two contact elements 5, 9 to a temperature between 200° C. and 450° C. The metal plate 2 may be planar or preformed. As indicated by reference numeral 33 in FIG. 10, one or both mounts 4, 8 for the contact elements 5, 9 can be cooled with water or oil.

The upper mount 8 can be moved in the direction of arrow PF towards the lower mount 4 by pressing and locking mechanisms 13, not shown in greater detail, when a metal plate 2 is located between the two contact elements 5, 9. As the metal plate 2 is heated between the contact elements 5, 9 in the presence of a pressure application, the two mounts 4, 8 are reliably locked with one another. The duration of the heating phase in the event of a metal plate 2 of light metal lasts less than 8 s. When a metal plate 2 of steel is involved, the time period of the heating phase is less than 20 s and is dependent on the thickness of the metal plate. 2

While the mount 8 is moved to an upper position, as shown in FIG. 1, the metal plate 2 enters the heating device 1 in the direction of arrow PF1 and is placed upon the lower contact element 5 integrated in the lower mount 4. After both mounts 4, 8 have moved together and have been locked, the metal plate 2 is heated in a single heating phase between the lower contact element 5 and the upper contact element 9. After moving the upper mount 8 upwards, the heated metal plate 2 is expelled from the heating device 1 in the direction of arrow PF2 and transferred for further processing, e.g. to undergo a forming process. Supply and removal of the metal plate 2 can be realized by grippers which are not shown in greater detail and may be configured in the form of transfer robots for example.

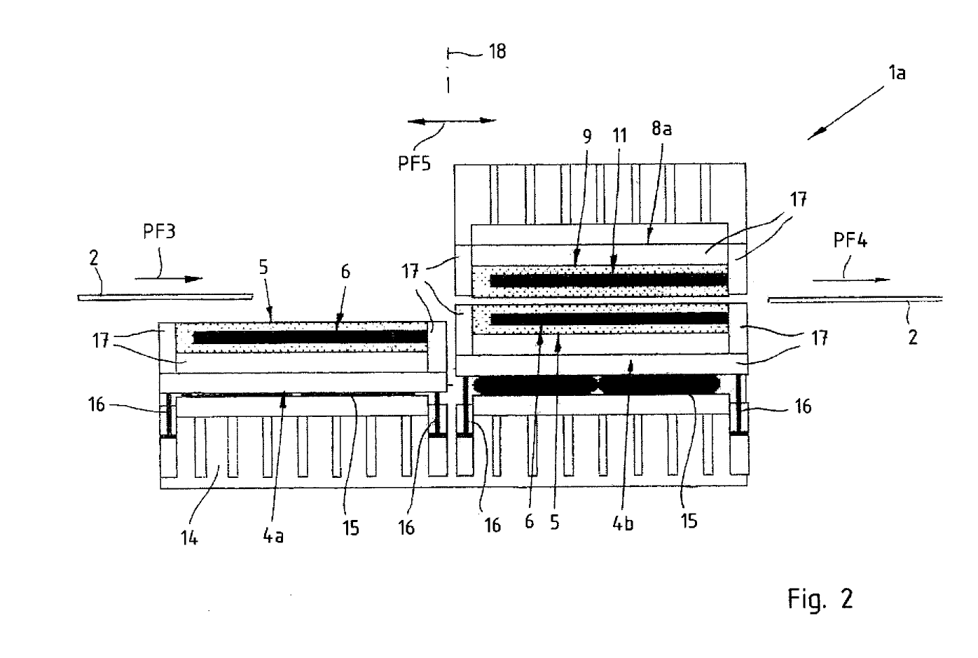

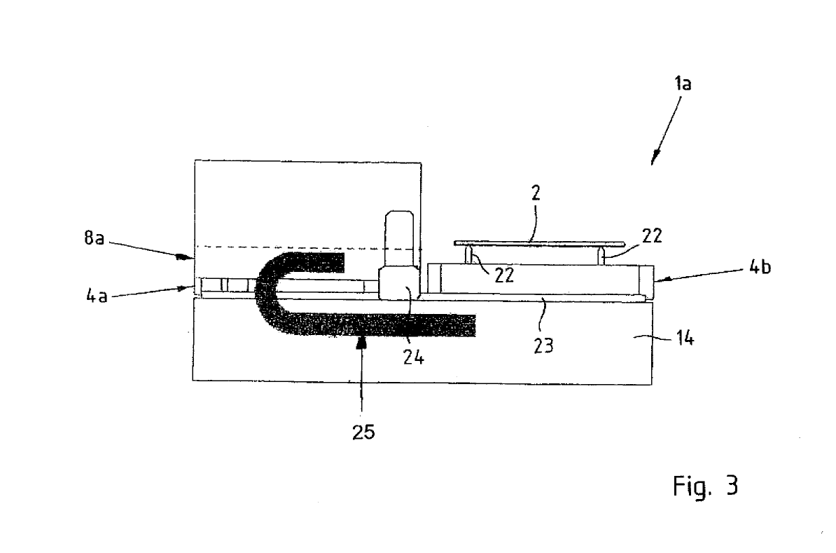

FIGS. 2 and 3 show a schematic, partly sectional view and a side view of a second embodiment of a heating device according to the present invention, generally designated by reference numeral 1a for heating a metal plate 2. The heating device la includes a base frame 14 and two lower mounts 4a, 4b which are supported side-by-side on the base frame 14 and guided for movement in a vertical direction and which have integrated therein heatable lower contact elements 5. Reference numeral 6 designates heating units in the lower contact elements 5.

The lower contact elements 5 are heated in a same manner as described with reference to the embodiment of FIG. 1 so that a detailed description is omitted for the sake of simplicity.

The lower mounts 4a, 4b rest on pneumatically-operated bellows 15 and can be moved vertically to a limited extent in the base frame 14 via guides 16.

FIGS. 2 and 3 further show an upper mount 8a having integrated therein a heatable upper contact element 9. Reference numeral 11 designates the heating unit for the upper contact element 9. For ease of illustration, the pressing and locking mechanisms, as designated in FIG. 1 with reference numeral 13, have been omitted here. The contact elements 5, 9 are isolated from the mounts 4a, 4b, 8a by insulations 17.

In accordance with the embodiment of FIG. 2, a metal plate 2 can enter the heating device 1a in the direction of arrow PF3 and placed on the lower contact element 5 integrated in the lower mount 4a, when the upper mount 8a is situated above the other lower mount 4b. During this time, the lower mount 4b and the upper mount 8a with integrated contact elements 5, 9 are moved towards one another with the assistance of pressing elements 13 (cf. FIG. 1) and the bellows 15 and locked to one another. Subsequently, a metal plate 2, placed between the contact elements 5, 9, is heated in the presence of the contact pressure. The pressing force may, optionally, be applied exclusively by the pressing elements 13 or exclusively by the bellows 15.

After the heating process, the lower mount 4b is lowered and the upper mount 8a is lifted and then shifted either according to arrow PF5 translatorily or rotatably about a vertical axis 18 to a position above the lower mount 4a which has received the cold metal plate 2, as shown in FIG. 3. Next, the upper mount 8a and the lower mount 4a are moved towards one another by the pressing mechanisms 13, 15, subsequently locked, and then the metal plate 2 is heated between the contact elements 5, 9 in the presence of the contact pressure. During this time, the previously heated metal plate 2 is expelled from the heating device 1a in the direction of arrow PF4 and transferred for further processing. The lower contact element 5 in the lower mount 4b can then be supplied in opposition to the direction of arrow PF4 with another cold metal plate 2 so as to repeat the afore-described heating cycle by translatorily shifting the upper mount 8a according to arrow PF5 or rotating the upper mount 8a about pivot axis 18.

The metal plates 2 are respectively heated also in this embodiment in a single heating phase between the contact elements 5, 9.

The shift of cold and heated metal plates 2 can be realized with the assistance of at least one transfer robot, not shown in greater detail.

FIG. 3 further shows the provision of pin-like lifting elements 22 which can move in a vertical direction. The lifting elements 22 are in point contact with an underside of a metal plate 2 and may be used to effect a fine-tuning of the heating process of the metal plate 2, if need be. This involves in particular a delayed upward movement of the lifting elements 22 which are in contact with the metal plate 2, when the contact elements 5, 9, positioned above one another, have been separated from one another.

FIG. 3 also shows schematically the presence of a horizontal rack 23 and a drive unit 24 in the form of a servomotor for example for moving the upper mount 8a from a position shown in FIG. 2 to a position shown in FIG. 3, and vice versa. A cable carrier 25 is further provided to accommodate various connection lines for power and/or heating fluids and/or cooling and protects at the same time against mechanical damage during horizontal movement of the mount 8a.

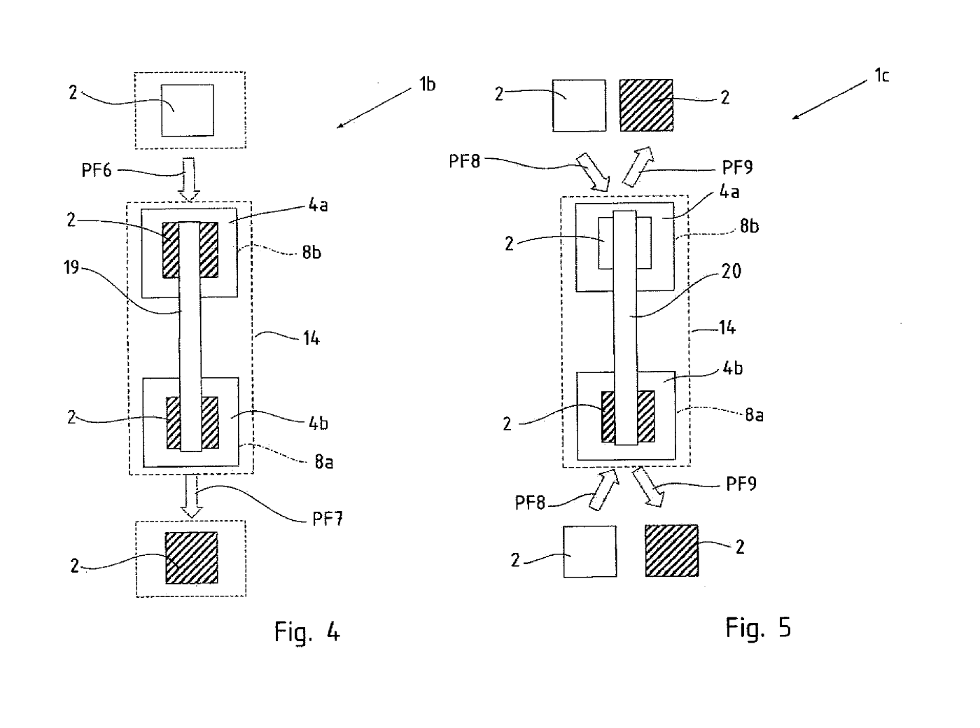

It is, of course, also conceivable within the scope of the embodiment of FIG. 2 to provide a heating device, as shown in FIG. 4 and generally designated by reference numeral 1b. In this embodiment, provision is made for a further upper mount 8b with integrated upper contact element 9 above the lower mount 4a with integrated lower contact element 5. The contact elements 5, 9 with integrated heating units 6, 11 are not shown here in detail for sake of simplicity.

The process sequence is such that a metal plate 2 that has been placed by a transfer robot for example between the contact elements 5, 9 of the lower mount 4a and the further upper mount 8b in a direction of arrow PF6 is first pre-heated and then heated to the end temperature between the contact elements 5, 9 of the second lower mount 4b and the upper mount 8a. This also may involve the use of a transfer robot.

This embodiment involves two heating phases that are independent from one another, whereby the upper mounts 8a, 8b and the integrated upper contact elements 9 are connected to one another by a support arm 19, at least temporarily, and may, optionally, be provided with suction elements, not shown in greater detail. These suction elements can be used to lift the pre-heated metal plates 2 from the lower contact element 5 in the lower mount 4b and to place them subsequently upon the lower contact element 5 in the lower mount 4b. As a result of this process step, another cold metal plate 2 can be supplied to the lower contact element 5 in the lower mount 4a according to arrow PF6, whereas a metal plate 2 that has been heated to the end temperature can be transferred from the lower contact element 5 of the lower mount 4b according to arrow PF7 for further processing.

Referring now to FIG. 5, there is shown a schematic, partly sectional view of a fourth embodiment of a heating device according to the present invention, generally designated by reference numeral 1c. This embodiment corresponds substantially to the embodiment of the heating device 1a of FIGS. 2 and 3, with the difference residing in that upper mounts 8a, 8b with integrated upper contact elements 9 are placed respectively above the lower mounts 4a, 4b with contact elements 5 integrated therein. The upper mounts 8a, 8b are connected to one another by a rigid support arm 20 and can be shifted by pressing elements 13 according to FIG. 1 simultaneously in the direction of the lower mounts 4a, 4b. The heating units 6, 11 in the contact elements 5, 9 are not shown in greater detail for the sake of simplicity.

In this embodiment, two cold metal plates 2 can be placed from two sides according to arrows PF8 upon the lower contact elements 5 in the lower mounts 4a, 4b, while the upper mounts 8a, 8b assume their elevated position, and after the lower contact elements 5 and the upper contact elements 9 are moved together, the metal plates 2 can then be heated in a single heating phase. After opening the heating device 1c by moving the mounts 4a, 4b, 8a, 8b apart, the heated metal plates 2 can be expelled from the same sides according to arrows PF9 and transferred for further processing. The movement of the metal plates 2 can be advantageously carried out by at least one transfer robot which is not shown in greater detail.

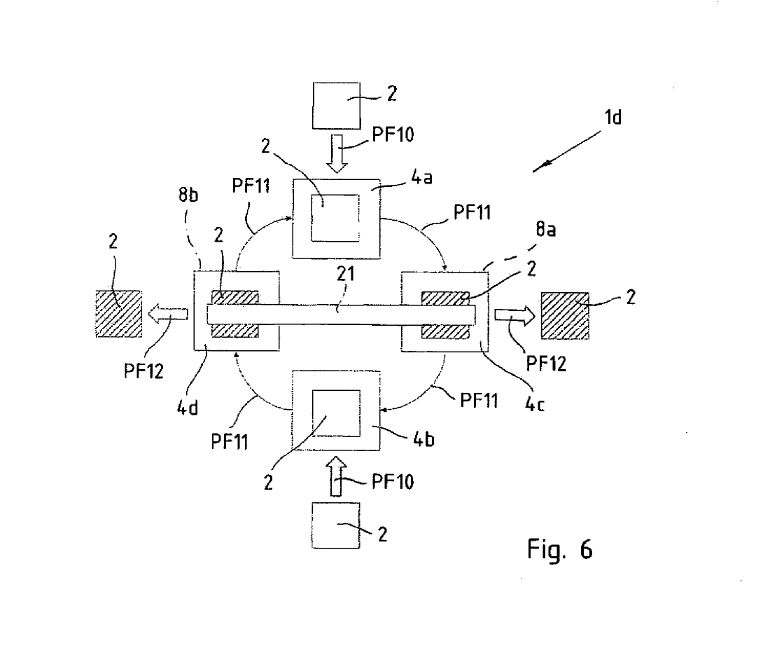

Referring now to FIG. 6, there is shown a schematic, partly sectional view of a fifth embodiment of a heating device according to the present invention, generally designated by reference numeral 1d. This embodiment involves the provision of four lower mounts 4a, 4b, 4c, 4d arranged in 90° offset relationship and having lower contact elements 5 integrated therein. The lower mounts 4a, 4b, 4c, 4d can be coupled and locked with two upper mounts 8a, 8b arranged in 180° offset relationship and having upper contact elements 9 integrated therein. The heating units 6, 11 in the contact elements 5, 9 are not shown in greater detail for the sake of simplicity.

The upper mounts 8a, 8b are connected to one another by a rigid support arm 21 and acted upon by pressing and locking elements 13 according to FIG. 1. The lower mounts 4a, 4b, 4c, 4d are rotatable, as indicated by arrows PF11.

Cold metal plates 2 are initially placed according to arrows PF10 onto the opposite lower contact elements 5 of the lower mounts 4a, 4b, while during this time two further metal plates 2 are heated between the lower contact elements 5 of the lower mounts 4c, 4d and the upper contact elements 9 of the upper mounts 8a, 8b in a single heating phase. The heated metal plates 2 are then expelled from the heating device 1d according to arrow PF12 for further processing, after the lower and upper mounts 4c, 4d, 8a, 8b have been moved apart.

Thereafter, or also simultaneously, the lower mounts 4a, 4b, 4c, 4d begin to move by 90° in clockwise direction. The metal plates 2 on the lower contact elements 5 of the lower mounts 4a, 4b are heated between the lower contact elements 5 and the upper contact elements 9 and at the same time further cold metal plates 2 are transferred to the now free lower contact elements 5 in the lower mounts 4c, 4d.

As soon as a cold metal plate 2 has been grabbed by a not shown gripper (transfer robot), the lower mounts 4a, 4b, 4c, 4d can begin to move by 90°. It is therefore not necessarily required to wait for a complete removal of the heated metal plates 2.

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. A method, comprising:
placing a metal plate in a heating device between lower and upper contact elements of a contour matching a contour of the metal plate;
supplying heating energy to at least one of the lower and upper contact elements which is made of a heat conducting material defined by a conductivity of at least 150 W/mK; and
heating the metal plate in at least one heating phase to a temperature of 200° C. to 450° C. for a time period of less than 120 s in the presence of a contact pressure.

2. The method of claim 1, wherein the lower contact element is integrated in a lower mount and the upper contact element is integrated in an upper mount.

3. The method of claim 1, wherein both the lower and upper contact elements are heated.

4. The method of claim 1, wherein the at least one contact element is heated electrically.

5. The method of claim 1, wherein the at least one contact element is heated hydraulically.

6. The method of claim 1, further comprising thermally insulating the at least one contact element against the environment.

7. The method of claim 1, further comprising applying lubricant onto the metal plate before or after heating the metal plate.

8. Apparatus for heating a metal plate, comprising a heating device having a lower contact element integrated in a lower mount and an upper contact element integrated in an upper mount, said lower and upper contact elements being movable vertically in relation to one another so as to be pressable against the metal plate and having confronting sides of a contour matching a contour of the metal plate, said heating device including a heating unit provided in at least one of the contact elements which is made of a heat conducting material defined by a conductivity of at least 150 W/mK.

9. The apparatus of claim 8, wherein the other one of the contact elements is made of a heat conducting material with a conductivity of at least 150 W/mK, and further comprising another heating unit provided in the other contact element.

10. The apparatus of claim 8, wherein the other one of the contact elements is unheated and made of a material defined by a conductivity which is less than the conductivity of the material of said one contact element.

11. The apparatus of claim 10, wherein the material of the other one of the contact elements is an insulating material.

12. The apparatus of claim 8, wherein the lower and upper mounts are arranged on top of one another, and further comprising pressing and/or locking units operatively connected to the lower and upper mounts.

13. The apparatus of claim 8, further comprising a fastener, provided on one of the upper and lower contact elements or one of the upper and lower mounts, for at least temporarily securing the metal plate.

14. The apparatus of claim 8, wherein the upper and lower contact elements are made of an aluminum alloy.

15. The apparatus of claim 8, wherein the upper and lower contact elements are made of a material having a thermal conductivity comparable to a thermal conductivity of aluminum alloy.

16. The apparatus of claim 8, wherein the at least one of the contact elements is thermally insulated from the environment.

17. The apparatus of claim 8, wherein the upper and lower contact elements have metal-plate-confronting sides which are coated.

18. The apparatus of claim 8, wherein the heating device includes a thermal insulation provided between the at least one of the contact elements and the mount thereof.

19. The apparatus of claim 8, wherein the mount for the at least one of the contact elements is cooled.

20. The apparatus of claim 8, wherein the heating unit is configured in the form of an inductor.

21. The apparatus of claim 8, wherein the heating unit is configured in the form of an encapsulated induction coil.

22. The apparatus of claim 8, wherein the heating unit is configured in the form of at least one passageway in which a heating fluid is guided.

23. Apparatus for heating a metal plate, comprising:
a heating device having a base frame, two lower mounts supported side-by-side on the base frame and guided by the base frame for movement in a vertical direction, each said lower mount having integrated therein a lower contact element, and an upper mount having integrated therein an upper contact element and movable above the lower mounts and lockable with the lower mounts in the presence of a contact pressure, wherein at least one of the lower and upper mounts is provided with a heating unit; and
a pressing mechanism integrated in the lower mounts.

24. Apparatus for heating a metal plate, comprising:
a heating device having a base frame, two lower mounts supported in spaced-apart relationship on the base frame and having each integrated therein a lower contact element, and two upper mounts having each integrated therein an upper contact element and arranged above the lower mounts and lockable with the lower mounts in the presence of a contact pressure, wherein at least one of the lower and upper contact elements placed above each other is provided with a heating unit; and
a pressing mechanism integrated between the base frame and the lower mounts.

25. Apparatus for heating a metal plate, comprising:
a heating device having four rotatably supported lower mounts which are arranged at 90° offset relation and have integrated therein lower contact elements, two upper mounts which are arranged at 180° offset relation and have integrated therein upper contact elements and which are coupleable and lockable with the lower mounts in the presence of a contact pressure, wherein at least one of the lower and upper contact elements placed above each other is provided with a heating unit; and
a pressing mechanism integrated between the base frame and the lower mounts.
